(19) United States
(12) Patent Application Publication
(10) Pub. No.: US 2013/0036676 A1
(43) Pub. Date: Feb. 14, 2013

(54) ELECTRONIC DEVICE

(71) Applicant: Yusuke Tani, Sakai-shi (JP)

(72) Inventor: Yusuke Tani, Sakai-shi (JP)

(73) Assignee: SANYO ELECTRIC CO., LTD., Osaka (JP)

(21) Appl. No.: 13/569,534

(22) Filed: Aug. 8, 2012

(30) Foreign Application Priority Data
Aug. 9, 2011 (JP) 2011-173666

(51) Int. Cl. E05D 15/16

(52) U.S. Cl. 49/414

(57) ABSTRACT

In an electronic device, a torsion spring is interposed between a first constructing member and a second constructing member, thereby biasing the second constructing member toward one movement end. The first constructing member has a lock receiving portion, to which the fixed end of the torsion spring is locked, whereas the second constructing member has an engagement receiving portion, with which the free end of the torsion spring is engaged, and an abutment receiving portion, against which an arm portion on the free end side of the torsion spring shall abut in the process in which the second constructing member is moved from the one movement end toward the other movement end. In the movement process of the second constructing member, the engagement receiving portion first presses the torsion spring, and thereafter, the abutment receiving portion presses the torsion spring.

### CROSS-REFERENCE TO RELATED APPLICATION

The Japanese Patent Application No. 2011-173666, upon which this present application is based, is hereby incorporated by reference.

### BACKGROUND OF THE INVENTION

1. Field of the Invention

The present invention relates to an electronic device in which a second constructing member can make a reciprocating motion along a predetermined path with respect to a first constructing member.

2. Description of Related Art

In various conventional electronic devices such as a digital camera, a cover serving as a second constructing member is slidably fitted between a closure position and an open position at the surface of a casing serving as a first constructing member, and further, a part such as a taking lens is exposed to the outside when the cover is opened.

In a cover opening/closing mechanism in the above-described electronic device, two torsion springs are interposed between the casing and the cover, wherein the first torsion spring biases the cover toward one movement end while the cover is moved from an intermediate position toward the one movement end, and further, the second torsion spring biases the cover toward the other movement end while the cover is moved from the intermediate position toward the other movement end.

However, in the above-described cover opening/closing mechanism, the cover is turned forward and reversely (i.e., clockwise and counterclockwise) in the process in which the cover slides between the closure position and the open position, and therefore, there has arisen the problem that the cover cannot make an accurate parallel motion.

### SUMMARY OF THE INVENTION

In view of the above, an object of the present invention is to suppress a turn generated in a second constructing member during the movement of the second constructing member in an electronic device in which the second constructing member is engaged with a first constructing member in such a manner as to freely make a reciprocating motion along a predetermined path.

In a first electronic device according to the present invention, a second constructing member is engaged with a first constructing member in such a manner as to freely make a reciprocating motion along a predetermined path; and a torsion spring having a fixed end and a free end is interposed between the first constructing member and the second constructing member, wherein the torsion spring biases the second constructing member toward one movement end in the process in which the second constructing member is moved toward the one movement end from an intermediate position on the predetermined path with respect to the first constructing member.

The first constructing member has a lock receiving portion, to which the fixed end of the torsion spring is locked, whereas the second constructing member has an engagement receiving portion, with which the free end of the torsion spring is engaged, and an abutment receiving portion, against which an arm portion on the free end side of the torsion spring shall abut in the process in which the second constructing member is moved from the one movement end toward the other movement end.

In this manner, in the process in which the second constructing member is moved from the one movement end toward the other movement end, the engagement receiving portion first presses the torsion spring so as to resiliently deform the torsion spring, and thereafter, the abutment receiving portion presses the torsion spring so as to resiliently deform the torsion spring.

In a second electronic device according to the present invention, a second constructing member is engaged with a first constructing member in such a manner as to freely make a reciprocating motion along a predetermined path; a first torsion spring having a fixed end and a free end and a second torsion spring having a fixed end and a free end are interposed between the first constructing member and the second constructing member, wherein the first torsion spring biases the second constructing member toward one movement end in the process in which the second constructing member is moved toward the one movement end from an intermediate position on the predetermined path whereas the second torsion spring biases the second constructing member toward the other movement end in the process in which the second constructing member is moved toward the other movement end from the intermediate position on the predetermined path.

The first constructing member has a first lock receiving portion, to which the fixed end of the first torsion spring is locked, and a second lock receiving portion, to which the fixed end of the second torsion spring is locked, and further, the second constructing member has a first engagement receiving portion, with which the free end of the first torsion spring is engaged, a second engagement receiving portion, with which the free end of the second torsion spring is engaged, and an abutment receiving portion, against which an arm portion on the free end side of the first torsion spring shall abut in the process in which the second constructing member is moved from the one movement end toward the other movement end.

In this manner, in the process in which the second constructing member is moved from the one movement end toward the other movement end, the first engagement receiving portion first presses the first torsion spring so as to resiliently deform the first torsion spring, and thereafter, the abutment receiving portion presses the first torsion spring so as to resiliently deform the first torsion spring.

In a third electronic device according to the present invention, a second constructing member is engaged with a first constructing member in such a manner as to freely make a reciprocating motion along a predetermined path; a first torsion spring having a fixed end and a free end and a second torsion spring having a fixed end and a free end are interposed between the first constructing member and the second constructing member, wherein the first torsion spring biases the second constructing member toward one movement end in the process in which the second constructing member is moved toward the one movement end from an intermediate position on the predetermined path whereas the second torsion spring biases the second constructing member toward the other movement end in the process in which the second constructing member is moved toward the other movement end from the intermediate position on the predetermined path.

The first constructing member has a first lock receiving portion, to which the fixed end of the first torsion spring is locked, and a second lock receiving portion, to which the fixed end of the second torsion spring is locked, and further, the second constructing member has a first engagement receiving portion, with which the free end of the first torsion spring is engaged, a second engagement receiving portion, with which the free end of the second torsion spring is engaged, a first abutment receiving portion, against which an arm portion on the free end side of the first torsion spring shall abut in the process in which the second constructing member is moved from the one movement end toward the other movement end, and a second abutment receiving portion, against which an arm portion on the free end side of the second torsion spring shall abut in the process in which the second constructing member is moved from the other movement end toward the one movement end.

In this manner, in the process in which the second constructing member is moved from the one movement end toward the other movement end, the first engagement receiving portion first presses the first torsion spring so as to resiliently deform the first torsion spring, and thereafter, the first abutment receiving portion presses the first torsion spring so as to resiliently deform the first torsion spring.

In contrast, in the process in which the second constructing member is moved from the other movement end toward the one movement end, the second engagement receiving portion first presses the second torsion spring so as to resiliently deform the second torsion spring, and thereafter, the second abutment receiving portion presses the second torsion spring so as to resiliently deform the second torsion spring.

### BRIEF DESCRIPTION OF THE DRAWINGS

FIG. 1 is a perspective view showing a digital camera in the state in which a cover is closed in a preferred embodiment according to the present invention;

FIG. 2 is a perspective view showing the digital camera in the state in which the cover is opened;

FIG. 3 is a perspective view showing the digital camera shown in FIG. 1 in the state in which the cover is detached;

FIG. 4 is a perspective view showing the digital camera shown in FIG. 2 in the state in which the cover is detached;

FIG. 5 is an exploded perspective view showing essential parts of the digital camera;

FIG. 6 is an enlarged perspective view showing an inside slide plate;

FIG. 7A is back view showing a change in state according to the reciprocating motion of the inside slide plate;

FIG. 7B is back view showing a change in state according to the reciprocating motion of the inside slide plate;

FIG. 8 is a view explanatory of force and moment that act on the inside slide plate in the state in which the inside slide plate reaches an upper movement end;

FIG. 9 is a view explanatory of force and moment that act on the inside slide plate in the state in which the inside slide plate reaches a lower movement end;

FIGS. 10A is back view showing a change in state according to the reciprocating motion of a slide plate in a digital camera devised in the process in which the Applicant has completed the present invention;

FIGS. 10B is back view showing a change in state according to the reciprocating motion of a slide plate in a digital camera devised in the process in which the Applicant has completed the present invention;

FIG. 11 is a view explanatory of force and moment that act on the slide plate in the state in which the slide plate reaches an upper movement end in the digital camera shown in FIGS. 10A and 10B; and

FIG. 12 is a view explanatory of force and moment that act on the slide plate in the state in which the slide plate reaches a lower movement end in the digital camera shown in FIGS. 10A and 10B.

### DETAILED DESCRIPTION OF THE PREFERRED EMBODIMENT

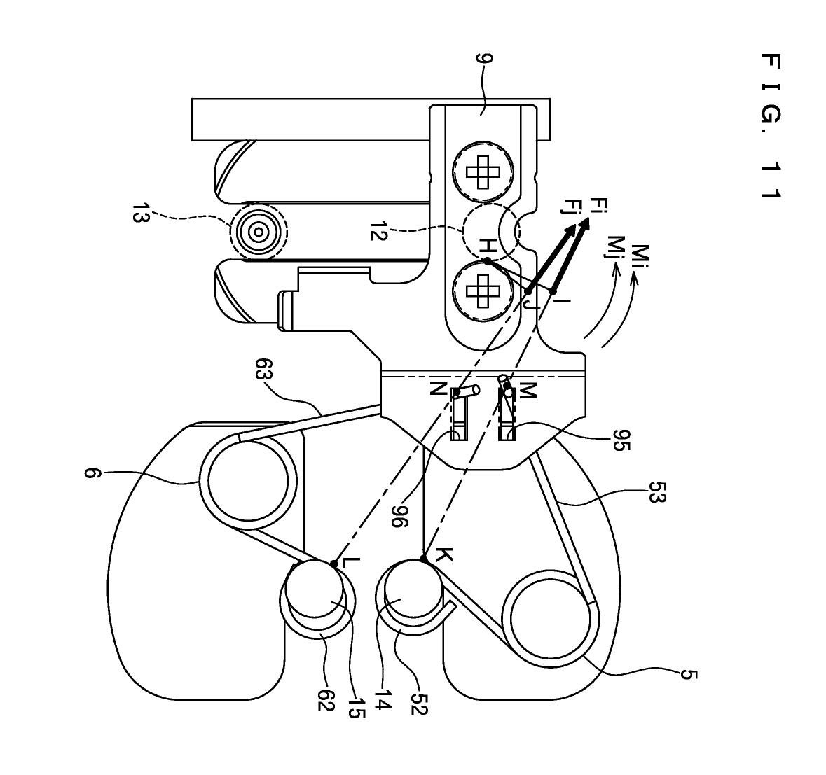

First of all, a description will be given of a cover opening/closing mechanism for a digital camera devised in the process in which the Applicant has completed the present invention. As shown in FIGS. 10A and 10B, in the cover opening/closing mechanism, a slide plate 9 is engaged with a front cabinet 10 in a vertically slidable manner, and further, the slide plate 9 is covered with a cover. The slide plate 9 is biased toward an upper movement end by a first torsion spring 5 shown in FIG. 10A, and further, is biased toward a lower movement end by a second torsion spring 6 shown in FIG. 10B.

A pair of upper and lower guide pins, not shown, disposed on the side of the slide plate 9 is fitted into guide slots, not shown, formed in the front cabinet 10 with a required play, and thus, the slide plate 9 is slidably guided.

However, the cover opening/closing mechanism shown in FIGS. 10A and 10B has experienced the problem that the slide plate 9 is turned forward and reversely (i.e., clockwise and counterclockwise) within the range of the play in the process in which the slide plate 9 makes a reciprocating motion between the upper movement end shown in FIG. 10A and the lower movement end shown in FIG. 10B, and therefore, the slide plate 9 cannot accurately make a parallel motion in a vertical direction.

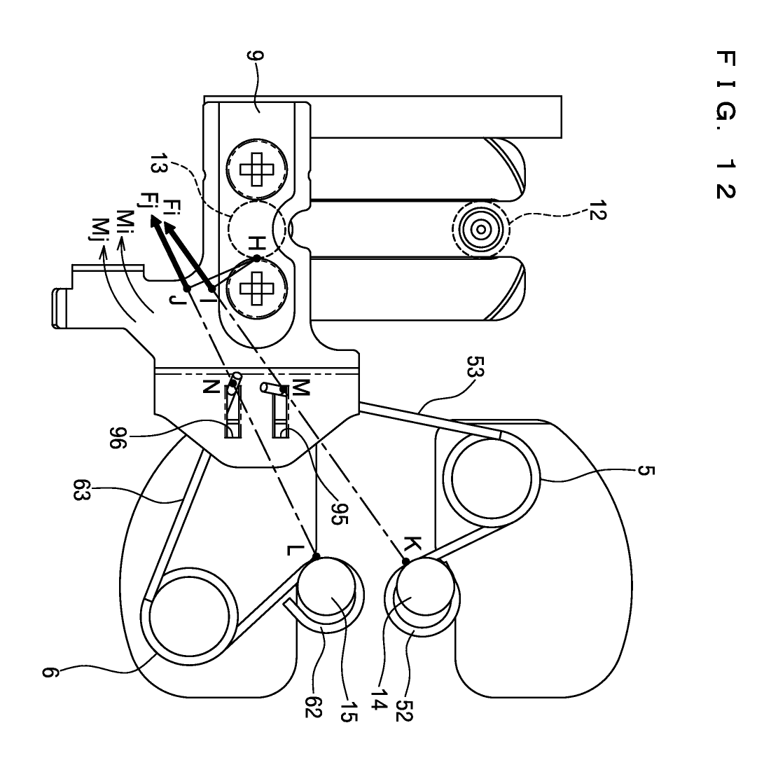

The cause of the above-described forward and reverse turn may be explained below with reference to FIGS. 11 and 12. As shown in FIGS. 11 and 12, a fixed portion 52 formed at the tip of one arm portion in the first torsion spring 5 is locked to a first lock receiving portion 14 formed on the front cabinet 10, and further, the tip of another arm portion 53 is engaged with a first engagement receiving portion 95 formed in the slide plate 9. Moreover, a fixed portion 62 formed at the tip of one arm portion in the second torsion spring 6 is locked to a second lock receiving portion 15 formed on the front cabinet 10, and further, the tip of another arm portion 63 is engaged with a second engagement receiving portion 96 formed in the slide plate 9.

Additionally, a pair of upper and lower guide pins 12, 13 disposed on the side of the slide plate 9 is fitted into guide slots, not shown, formed in the front cabinet 10 with a required play, and thus, the slide plate 9 is slidably guided.

As shown in FIG. 11, in the state in which the slide plate 9 reaches the upper movement end, the first torsion spring 5 generates resilient repulsion in an open direction between the fixed portion 52 locked to the first lock receiving portion 14 and a free end engaged with the first engagement receiving portion 95 of the slide plate 9 so as to act a force Fi on the slide plate 9 in a direction along a straight line connecting points K and M in FIG. 11.

In the meantime, the second torsion spring 6 generates resilient repulsion in an open direction between the fixed portion 62 locked to the second lock receiving portion 15 and a free end engaged with the second engagement receiving portion 96 of the slide plate 9 so as to act on the slide plate 9 a force Fj in a direction along a straight line connecting points L and N in FIG. 11.

Consequently, the side wall of the guide slot abuts against the first guide pin 12, thereby producing, in the slide plate 9 on a point H in FIG. 11, a moment Mi determined by a product obtained by multiplying the force Fi by a distance from the point H to a point I in FIG. 11 and a moment Mj determined by a product obtained by multiplying the force Fj by a distance from the point H to a point J in FIG. 11. These moments Mi and Mj each exert counterclockwise.

To the contrary, as shown in FIG. 12, in the state in which the slide plate 9 reaches the lower movement end, the first torsion spring 5 acts on the slide plate 9 the force Fi in the direction along the straight line connecting the points K and M in FIG. 11 by the resilient repulsion in the open direction.

In the meantime, the second torsion spring 6 acts on the slide plate 9 the force Fj in the direction along the straight line connecting the points L and N in FIG. 11 by the resilient repulsion in the open direction.

As a consequence, the side wall of the guide slot abuts against the second guide pin 13, thereby producing, in the slide plate 9 on the point H in FIG. 11, the moment Mi determined by the product obtained by multiplying the force Fi by the distance from the point H to the point I in FIG. 11 and the moment Mj determined by the product obtained by multiplying the force Fj by the distance from the point H to the point J in FIG. 11. These moments Mi and Mj each exert clockwise.

Thus, the slide plate 9 receives the moments reverse to each other in the first and second halves of the process of the movement thereof in the process in which the slide plate 9 is moved from the upper movement end shown in FIG. 11 to the lower movement end shown in FIG. 12 or the process in which the slide plate 9 is moved from the lower movement end shown in FIG. 12 to the upper movement end shown in FIG. 11, thereby inducing a turn in the slide plate 9.

The Applicant has earnestly made studies so as to suppress the turn induced in the slide plate 9 in the cover opening/closing mechanism in the above-described digital camera, and finally, has completed the present invention. A detailed description will be described below of a mode carrying out the present invention in a digital camera with reference to the attached drawings.

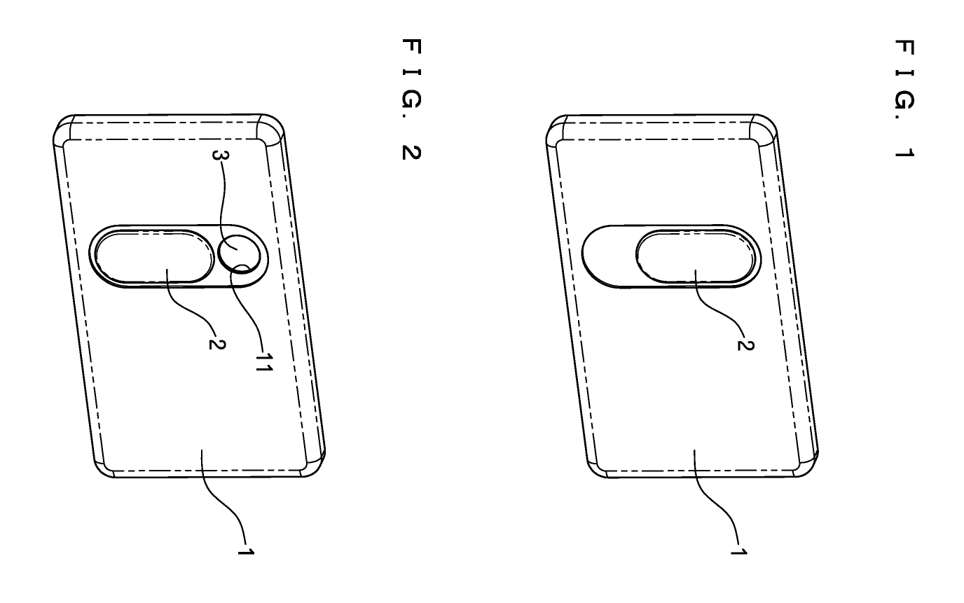

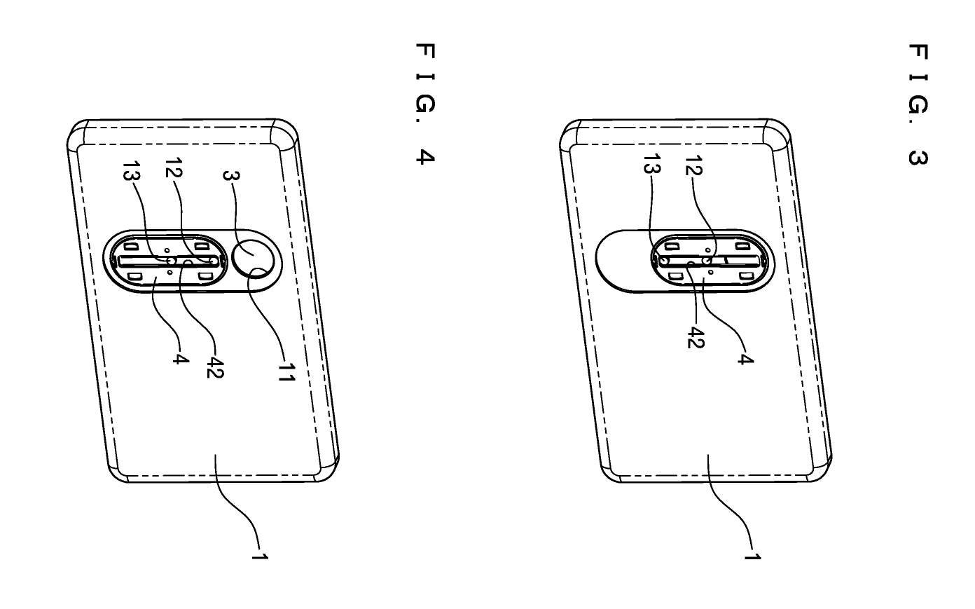

A digital camera in one preferred embodiment according to the present invention is provided with an elongated cover 2 that can make a vertical reciprocating motion at the front surface of a casing 1, as shown in FIGS. 1 and 2. The cover 2 is moved from an upper movement end shown in FIG. 1 to a lower movement end shown in FIG. 2, so as to release a window 11, thereby exposing a taking lens 3 to the outside.

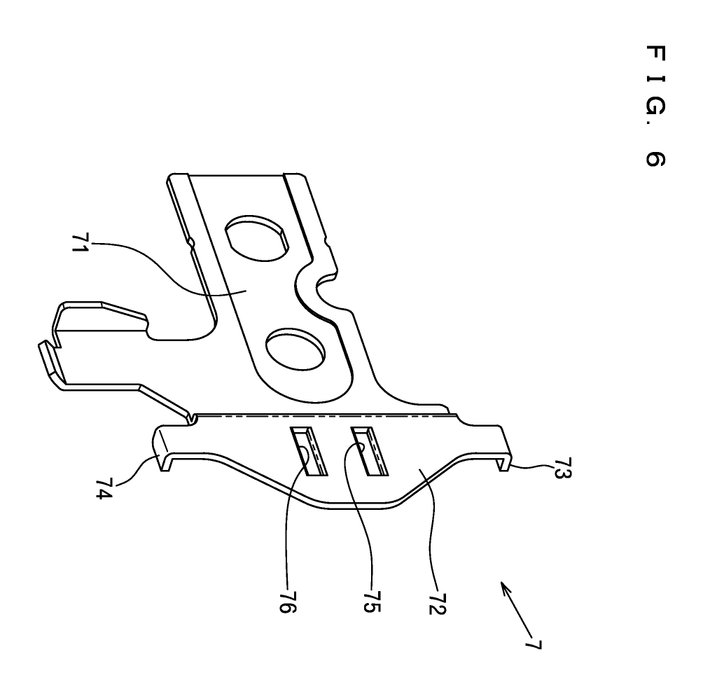

As shown in FIG. 5, an outside slide plate 4 and an inside slide plate 7 hold a front cabinet 10 constituting the casing 1 therebetween, and further, two screws 8 and 8 are screwed into two bosses 41 and 41 formed on the outside slide plate 4 through round holes formed in the inside slide plate 7 and slots 16 and 17 formed in the front cabinet 10, thus integrating the outside slide plate 4 and the inside slide plate 7 into each other.

The cover 2 shown in FIG. 1 is fixed onto the outside slide plate 4.

As shown in FIG. 5, an elongated guide slot 42 is bored in the outside slide plate 4.

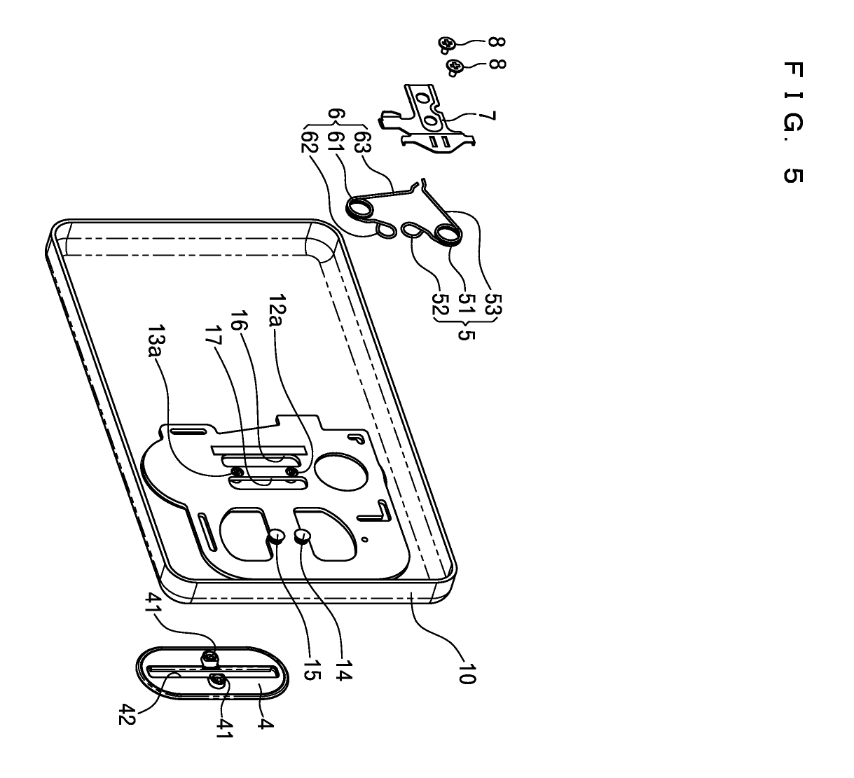

As shown in FIG. 3, a first guide pin 12 and a second guide pin 13 to engage with the guide slot 42 formed in the outside slide plate 4 with plays are vertically arranged in a projecting manner in the front cabinet 10. As shown in FIGS. 3 and 4, when both of the guide pins 12 and 13 slide along the guide slot 42, the outside slide plate 4 and the inside slide plate 7 are slidably guided.

In this manner, the cover 2 can make the reciprocating motion between the upper movement end shown in FIG. 1 and the lower movement end shown in FIG. 2.

As shown in FIG. 5, a first lock receiving portion 14 and a second lock receiving portion 15 project from the inner surface of the front cabinet 10 sideways of the slot 17.

A first torsion spring 5 is fixed to the first lock receiving portion 14 whereas a second torsion spring 6 is fixed to the second lock receiving portion 15.

The first torsion spring 5 includes a coil portion 51 and two arm portions extending from the coil portion 51. A fixed portion 52 formed at the tip of one of the arm portions is locked to the first lock receiving portion 14.

The second torsion spring 6 includes a coil portion 61 and two arm portions extending from the coil portion 61. A fixed portion 62 formed at the tip of one of the arm portions is locked to the second lock receiving portion 15.

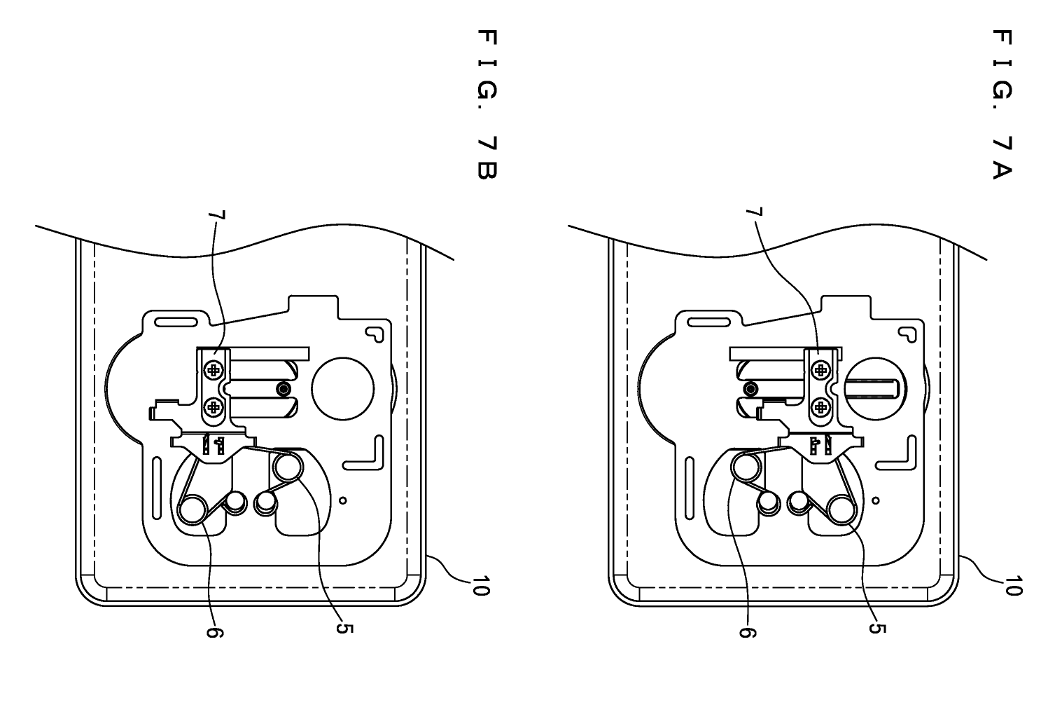

As shown in FIG. 6, the inside slide plate 7 includes a laterally elongated plate portion 71 and a vertically elongated flange portion 72 projecting sideways of the plate portion 71. The flange portion 72 has a first engagement receiving portion 75 and a second engagement receiving portion 76 formed in a laterally elongated manner.

Moreover, a first abutment receiving portion 73 and a second abutment receiving portion 74 project from both of vertical ends of the flange portion 72 into the shape of a tongue piece.

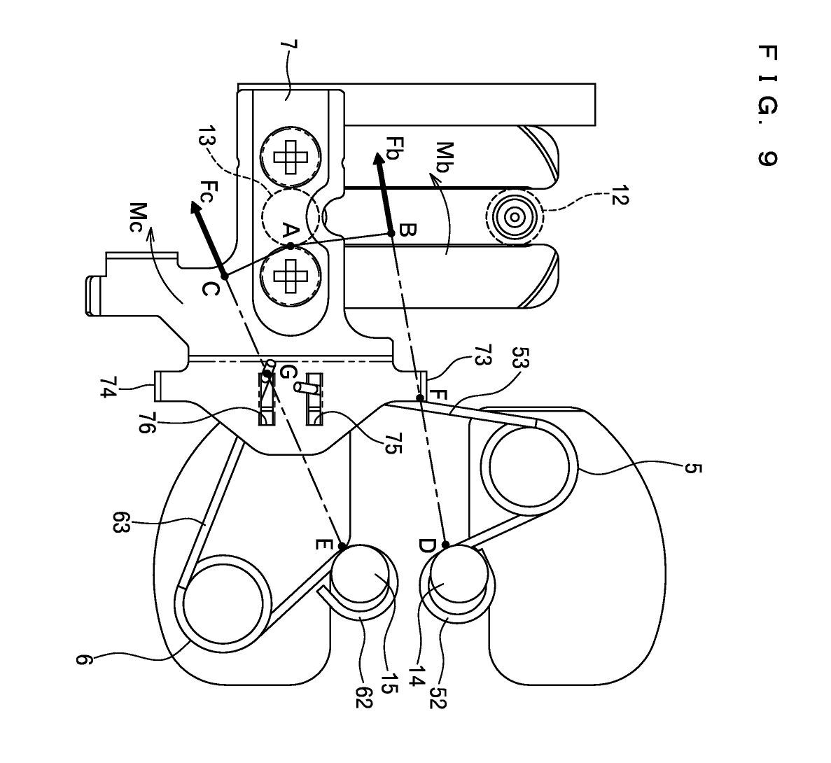

As shown in FIG. 8, the tip of an arm portion 53 on a free end side in the first torsion spring 5 is engaged with the first engagement receiving portion 75 of the inside slide plate 7 whereas the tip of an arm portion 63 on a free end side in the second torsion spring 6 is engaged with the second engagement receiving portion 76 of the inside slide plate 7.

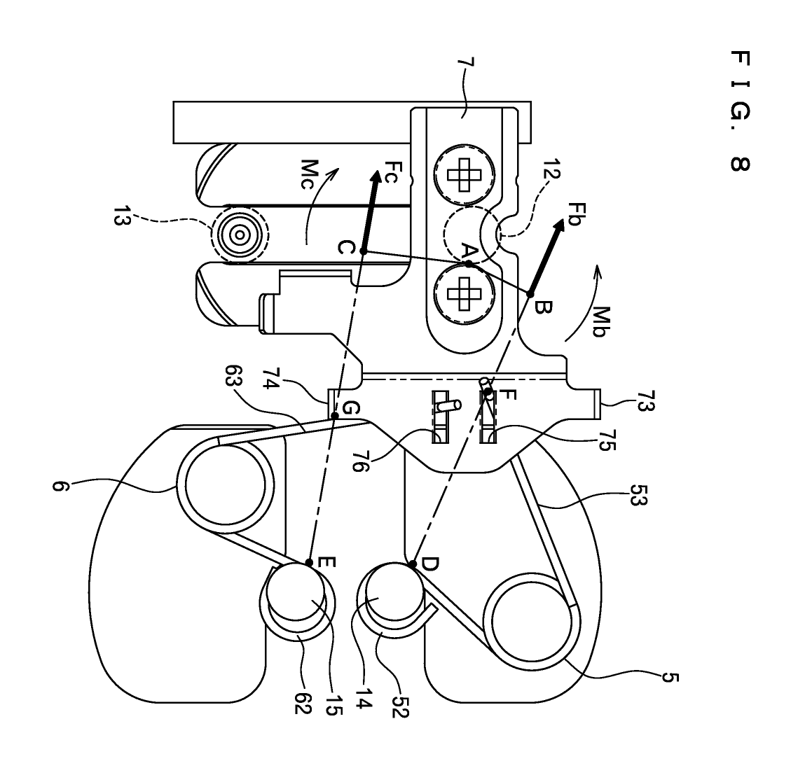

In this manner, the inside slide plate 7 is depressed upward by the first torsion spring 5 to be thus kept at the upper movement end when the inside slide plate 7 reaches the upper movement end, as shown in FIG. 7A.

In contrast, the inside slide plate 7 is depressed downward by the second torsion spring 6 to be thus kept at the lower movement end when it reaches the lower movement end, as shown in FIG. 7B.

When the inside slide plate 7 is moved down to an intermediate position between the upper movement end and the lower movement end against the bias of the first torsion spring 5 in the process in which the inside slide plate 7 is moved from the upper movement end shown in FIG. 7A toward the lower movement end shown in FIG. 7B, the inside slide plate 7 is automatically moved down to the lower movement end thereafter by the bias of the second torsion spring 6.

To the contrary, when the inside slide plate 7 is moved up to the intermediate position against the bias of the second torsion spring 6 in the process in which the inside slide plate 7 is moved from the lower movement end shown in FIG. 7B toward the upper movement end shown in FIG. 7A, the inside slide plate 7 is automatically moved up to the upper movement end thereafter by the bias of the first torsion spring 5.

As shown in FIG. 8, in the state in which the inside slide plate 7 reaches the upper movement end, the tip of the arm portion 53 on the free end side in the first torsion spring 5 is received in the first engagement receiving portion 75 of the inside slide plate 7, so that the first engagement receiving portion 75 presses the arm portion 53 on the free end side in the first torsion spring 5, thereby resiliently deforming the first torsion spring 5.

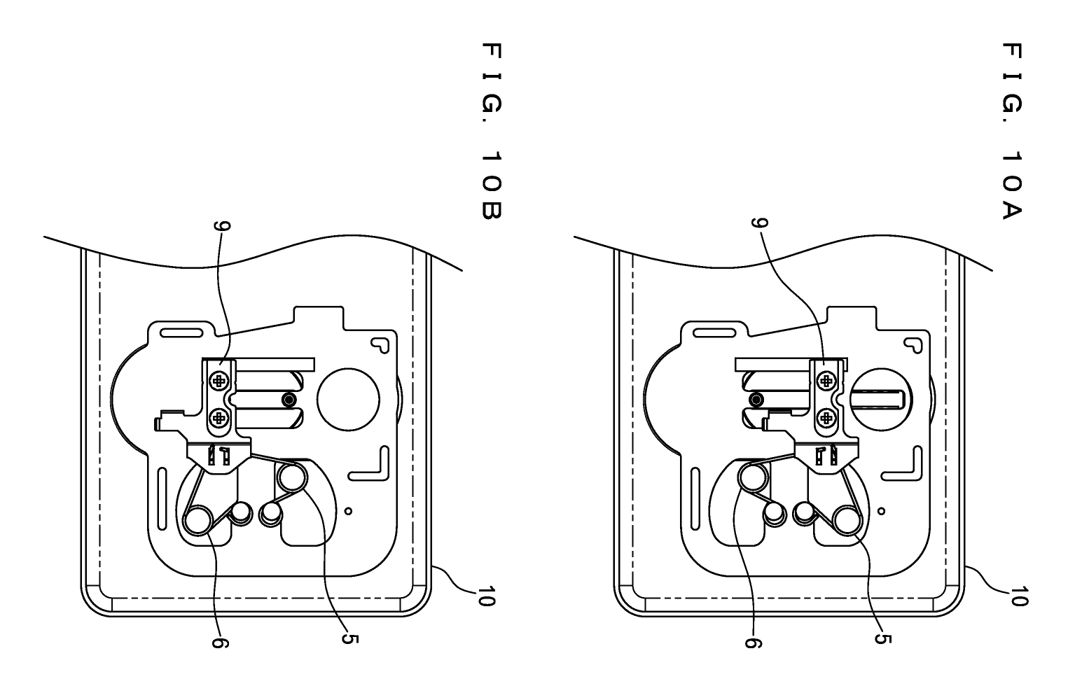

In the process in which the inside slide plate 7 is moved from this position toward the lower movement end shown in FIG. 9, the first abutment receiving portion 73 of the inside slide plate 7 abuts against the arm portion 53 on the free end side of the first torsion spring 5, and then, the first abutment receiving portion 73 presses the arm portion 53 on the free end side of the first torsion spring 5 in the state in which the inside slide plate 7 reaches the lower movement end, thereby resiliently deforming the first torsion spring 5.

In this state, the tip of the arm portion 53 on the free end side of the first torsion spring 5 is engaged with the first engagement receiving portion 75 of the inside slide plate 7 in a loose manner without exerting any bias.

As shown in FIG. 9, in the state in which the inside slide plate 7 reaches the lower movement end, the tip of the arm portion 63 on the free end side in the second torsion spring 6 is received in the second engagement receiving portion 76 of the inside slide plate 7, so that the second engagement receiving portion 76 presses the arm portion 63 on the free end side in the second torsion spring 6, thereby resiliently deforming the second torsion spring 6.

In the process in which the inside slide plate 7 is moved from this position toward the upper movement end shown in FIG. 8, the second abutment receiving portion 74 of the inside slide plate 7 abuts against the arm portion 63 on the free end side of the second torsion spring 6, and then, the second abutment receiving portion 74 presses the arm portion 63 on the free end side of the second torsion spring 6 in the state in which the inside slide plate 7 reaches the upper movement end, thereby resiliently deforming the second torsion spring 6.

In this state, the tip of the arm portion 63 on the free end side of the second torsion spring 6 is engaged with the second engagement receiving portion 76 of the inside slide plate 7 in a loose manner without exerting any bias.

As shown in FIG. 8, in the state in which the inside slide plate 7 reaches the upper movement end, the first torsion spring 5 generates a resilient repulsion in an open direction with reference to the fixed portion 52 as a fulcrum (a point D) and the tip of the arm portion 53 on the free end side in contact with the inside slide plate 7 as a point of a lever where force is applied (a point F), and thus, a force Fb along a straight line connecting the points D and F acts on the inside slide plate 7.

As a consequence, the first guide pin 12 is brought into press-contact with a right wall of the guide slot 42, as shown in FIG. 8 (hereinafter simply referred to as a right wall). A counterclockwise moment Mb obtained by a product (Fb×Lb) obtained by multiplying the force Fb by a distance Lb from the point A to the point B in FIG. 8 is produced in the inside slide plate 7 on the resultant press-contact point (a point A).

The second torsion spring 6 generates a resilient repulsion in an open direction with reference to the fixed portion 62 as a fulcrum (a point E) and the intermediate point of the arm portion 63 on the free end side in contact with the inside slide plate 7 as a point of a lever where force is applied (a point G), and thus, a force Fc along a straight line connecting the points E and G acts on the inside slide plate 7.

As a consequence, the first guide pin 12 is brought into press-contact with the right wall of the guide slot 42. A clockwise moment Mc obtained by a product (Fc×Lc) obtained by multiplying the force Fc by a distance Lc from the point A to the point C in FIG. 8 is produced in the inside slide plate 7 on the resultant press-contact point (the point A).

Here, the distance between the points A and C can be set to be greater than the distance between the points A and B, thereby establishing the relationship of Mc>Mb.

Thus, a clockwise moment (Mc−Mb) can act on the inside slide plate 7.

In this manner, the inside slide plate 7 is pressed leftward in FIG. 8 at the point A (hereinafter simply referred to as leftward). At the same time, the inside slide plate 7 receives the clockwise moment on the point A, and therefore, the second guide pin 13 is brought into press-contact with the right wall of the guide slot 42.

Consequently, the first guide pin 12 and the second guide pin 13 are brought into press-contact with the right wall of the guide slot 42, so that the inside slide plate 7 and the outside slide plate 4 are held at a position deviated leftward as a whole within the range of the play with respect to the guide slot 42.

In contrast, as shown in FIG. 9, in the state in which the inside slide plate 7 reaches the lower movement end, the first torsion spring 5 generates the resilient repulsion in the open direction with reference to the fixed portion 52 as the fulcrum (the point D) and the intermediate point of the arm portion 53 on the free end side in contact with the inside slide plate 7 as the point of a lever where force is applied (the point F), and thus, the force Fb along the straight line connecting the points D and F acts on the inside slide plate 7.

As a consequence, the second guide pin 13 is brought into press-contact with the right wall of the guide slot 42. The counterclockwise moment Mb obtained by the product (Fb×b) obtained by multiplying the force Fb by the distance Lb from the point A to the point B in FIG. 9 is produced in the inside slide plate 7 on the resultant press-contact point (the point A).

Moreover, the second torsion spring 6 generates the resilient repulsion in the open direction with reference to the fixed portion 62 as the fulcrum (the point E) and the tip of the arm portion 63 on the free end side in contact with the inside slide plate 7 as the point of a lever where force is applied (the point G), and thus, the force Fc along the straight line connecting the points E and G acts on the inside slide plate 7.

As a consequence, the second guide pin 13 is brought into press-contact with the right wall of the guide slot 42. The clockwise moment Mc obtained by the product (Fc×Lc) obtained by multiplying the force Fc by the distance Lc from the point A to the point C in FIG. 9 is produced in the inside slide plate 7 on the resultant press-contact point (the point A).

Here, the distance between the points A and B can be set to be greater than the distance between the points A and C, thereby establishing the relationship of Mb>Mc.

Thus, the counterclockwise moment (Mb−Mc) can act on the inside slide plate 7.

In this manner, the inside slide plate 7 is pressed leftward at the point A. At the same time, the inside slide plate 7 receives the counterclockwise moment on the point A, and therefore, the first guide pin 12 is brought into press-contact with the right wall of the guide slot 42.

Consequently, the first guide pin 12 and the second guide pin 13 are brought into press-contact with the right wall of the guide slot 42, so that the inside slide plate 7 and the outside slide plate 4 are held at a position deviated leftward as a whole within the range of the play with respect to the guide slot 42.

Hence, one of the side walls of the guide slot 42 is brought into slide-contact with both of the guide pins 12 and 13 all the time irrespective of the slide direction and the slide position in the process in which the inside slide plate 7 makes the reciprocating motion between the state in which the inside slide plate 7 reaches the upper movement end, as shown in FIG. 7A, and the state in which the inside slide plate 7 reaches the lower movement end, as shown in FIG. 7B. In this manner, both of the slide plates 7 and 4 can be suppressed from making the forward and reverse turns, and therefore, can make the vertical parallel movement.

Here, the configuration of each of the construction elements according to the present invention is not limited to that in the above-described preferred embodiment, various modifications can be implemented by experts in the technical field within the scope without departing from the spirit of the present invention claimed in claims. For example, the movement path of the second constructing member (i.e., the cover) with respect to the first constructing member (i.e., the casing) is not limited to the straight line, but a moderate arcuate line may be allowed. Alternatively, the inside slide plate 7 and the outside slide plate 4 may be configured integrally with each other.

Moreover, although the second constructing member is biased in the two directions by the two torsion springs in the above-described preferred embodiment, the present invention may be applied to a configuration in which a single torsion spring biases the second constructing member. Turns that may occur during the movement of the second constructing member can be suppressed also in this embodiment.

In addition, although the abutment receiving portion, against which the arm portion on the free end side of each of the torsion springs shall abut during the movement of the second constructing member, is formed in each of the two torsion springs in the above-described preferred embodiment, there may be adopted an embodiment in which an abutment receiving portion, against which the arm portion on the free end side of only either one of the two torsion springs shall abut during the movement of the second constructing member, is formed in either of the torsion springs.

In the above-described embodiment, the two torsion springs bias the second constructing member in the two directions, and further, the moments can be generated in the same direction in the second constructing member during the first and second halves of the movement process of the second constructing member in either one direction, thus suppressing the turn of the second constructing member.

The present invention can be applied to not only the configuration in which the reciprocating motion of the cover 2 is guided to the casing 1 but also a configuration in which the guide pins and guide slot guide the reciprocating motion of the second casing on the first casing in a slide type electronic device, for example.

Alternatively, the present invention encompasses a mode in which the second constructing member is exemplified by a lens cover for a projector, a protective cover for a connecting terminal, a cover for a container containing a battery, a memory card, or an accessory, and a protective cover for an operating switch.

Furthermore, the present invention may be applied to a configuration in which a second constructing member per se serves as a switch or an operating member for an inside mechanism or to a configuration in which a letter or a mark printed on a first constructing member is viewed or concealed according to the movement of a second constructing member.

What is claimed is:

1. An electronic device comprising:
a first constructing member;
a second constructing member to be engaged with the first constructing member in such a manner as to freely make a reciprocating motion along a predetermined path; and
a torsion spring having a fixed end and a free end and being interposed between the first constructing member and the second constructing member, the torsion spring biasing the second constructing member toward one movement end in the process in which the second constructing member is moved toward the one movement end from an intermediate position on the predetermined path with respect to the first constructing member;
wherein the first constructing member has a lock receiving portion, to which the fixed end of the torsion spring is locked, whereas the second constructing member has an engagement receiving portion, with which the free end of the torsion spring is engaged, and an abutment receiving portion, against which an arm portion on the free end side of the torsion spring shall abut in the process in which the second constructing member is moved from the one movement end toward the other movement end; and
wherein in the process in which the second constructing member is moved from the one movement end toward the other movement end, the engagement receiving portion first presses the torsion spring so as to resiliently deform the torsion spring, and thereafter, the abutment receiving portion presses the torsion spring so as to resiliently deform the torsion spring.

2. An electronic device comprising:
a first constructing member;
a second constructing member to be engaged with the first constructing member in such a manner as to freely make a reciprocating motion along a predetermined path;
a first torsion spring having a fixed end and a free end and being interposed between the first constructing member and the second constructing member, the first torsion spring biasing the second constructing member toward one movement end in the process in which the second constructing member is moved toward the one movement end from an intermediate position on the predetermined path; and
a second torsion spring having a fixed end and a free end and being interposed between the first constructing member and the second constructing member, the second torsion spring biasing the second constructing member toward the other movement end in the process in which the second constructing member is moved toward the other movement end from the intermediate position on the predetermined path;
wherein the first constructing member has a first lock receiving portion, to which the fixed end of the first torsion spring is locked, and a second lock receiving portion, to which the fixed end of the second torsion spring is locked;
wherein the second constructing member has a first engagement receiving portion, with which the free end of the first torsion spring is engaged, a second engagement receiving portion, with which the free end of the second torsion spring is engaged, and an abutment receiving portion, against which an arm portion on the free end side of the first torsion spring shall abut in the process in which the second constructing member is moved from the one movement end toward the other movement end; and
wherein in the process in which the second constructing member is moved from the one movement end toward the other movement end, the first engagement receiving portion first presses the first torsion spring so as to resiliently deform the first torsion spring, and thereafter, the abutment receiving portion presses the first torsion spring so as to resiliently deform the first torsion spring.

3. An electronic device comprising:
a first constructing member;
a second constructing member to be engaged with the first constructing member in such a manner as to freely make a reciprocating motion along a predetermined path;
a first torsion spring having a fixed end and a free end and being interposed between the first constructing member and the second constructing member, the first torsion spring biasing the second constructing member toward one movement end in the process in which the second constructing member is moved toward the one movement end from an intermediate position on the predetermined path; and
a second torsion spring having a fixed end and a free end and being interposed between the first constructing member and the second constructing member, the second torsion spring biasing the second constructing member toward the other movement end in the process in which the second constructing member is moved toward the other movement end from the intermediate position on the predetermined path;
wherein the first constructing member has a first lock receiving portion, to which the fixed end of the first torsion spring is locked, and a second lock receiving portion, to which the fixed end of the second torsion spring is locked;
wherein the second constructing member has a first engagement receiving portion, with which the free end of the first torsion spring is engaged, a second engagement receiving portion, with which the free end of the second torsion spring is engaged, a first abutment receiving portion, against which an arm portion on the free end side of the first torsion spring shall abut in the process in which the second constructing member is moved from the one movement end toward the other movement end, and a second abutment receiving portion, against which an arm portion on the free end side of the second torsion spring shall abut in the process in which the second constructing member is moved from the other movement end toward the one movement end;
wherein in the process in which the second constructing member is moved from the one movement end toward the other movement end, the first engagement receiving portion first presses the first torsion spring so as to resiliently deform the first torsion spring, and thereafter, the first abutment receiving portion presses the first torsion spring so as to resiliently deform the first torsion spring; and
wherein in the process in which the second constructing member is moved from the other movement end toward the one movement end, the second engagement receiving portion first presses the second torsion spring so as to resiliently deform the second torsion spring, and thereafter, the second abutment receiving portion presses the second torsion spring so as to resiliently deform the second torsion spring.

4. The electronic device according to claim 3, wherein in the second constructing member, the first engagement receiving portion and the second engagement receiving portion are formed respectively into a slot, and further, the first abutment receiving portion and the second abutment receiving portion project outside of the engagement receiving portions, respectively, in a tongue-like shape.

5. The electronic device according to claim 1, wherein two guide pins project on a movement path for the second constructing member in the first constructing member, and further, guide slots, to which the two guide pins are slidably fitted, are formed in the second constructing member, so that the reciprocating motion of the second constructing member is guided on the first constructing member.

6. The electronic device according to claim 2, wherein two guide pins project on a movement path for the second constructing member in the first constructing member, and further, guide slots, to which the two guide pins are slidably fitted, are formed in the second constructing member, so that the reciprocating motion of the second constructing member is guided on the first constructing member.

7. The electronic device according to claim 3, wherein two guide pins project on a movement path for the second constructing member in the first constructing member, and further, guide slots, to which the two guide pins are slidably fitted, are formed in the second constructing member, so that the reciprocating motion of the second constructing member is guided on the first constructing member.

8. The electronic device according to claim 4, wherein two guide pins project on a movement path for the second constructing member in the first constructing member, and further, guide slots, to which the two guide pins are slidably fitted, are formed in the second constructing member, so that the reciprocating motion of the second constructing member is guided on the first constructing member.
